(19) United States
(12) Patent Application Publication
(10) Pub. No.: US 2004/0156268 A1
(43) Pub. Date: Aug. 12, 2004

(54) Device for tracking breast feeding sessions and methods of use thereof

(76) Inventor: Catherine M. Hall, San Diego, CA (US)

Correspondence Address: DAVID R PRESTON & ASSOCIATES, 12625 HIGH BLUFF DRIVE, SUITE 205, SAN DIEGO, CA, 92130, US

(21) Appl. No.: 10/758,874

(22) Filed: Jan. 16, 2004

Related U.S. Application Data
(60) Provisional application No. 60/446,309, filed on Feb. 10, 2003.

(51) Int. Cl. G04B 47/00

(52) U.S. Cl. 368/10

(57) ABSTRACT

The present invention relates generally to the field of breast feeding, and particularly to a device for tracking breast feeding sessions and methods of use thereof by a nursing mother. The present invention is particularly adaptable as a reminder to a nursing mother of which breast was used during the previous breast feeding session, and thereby facilitating alternating breast feeding sessions. The present invention can be combined as an addition to any garment or article of clothing worn by a nursing mother for tracking alternating breast feeding sessions.

### RELATED APPLICATIONS

The present application claims benefit of priority to U.S. Provisional Patent Application Serial No. 60/446,309, filed Feb. 10, 2003, which is incorporated by reference herein in its entirety.

### FIELD OF INVENTION

The present invention relates generally to the field of breast feeding, and particularly to a device for tracking breast feeding sessions and methods of use thereof by a nursing mother.

### BACKGROUND OF THE INVENTION

Nursing mothers use various methods of determining which breast was used in the previous breast feeding session. Some utilize a safety pin on the mother's bra or nightgown as an indicator of which breast was used in the previous breast feeding session. Also, a variety of nursing bras are commercially available. These nursing bras are available in a variety of configuration, such as nursing bras that allowing the opening and closing of alternating bra cups or bras with permanently attached indicators.

Many of the available methods and nursing bras for determining which breast was used in the previous breast feeding session are inefficient and pose a risk of injury to the nursing infant. The use of nursing bras may be confusing, and the need to purchase nursing bras corresponds to higher expense. While there has been a trend to produce safer and more cost effective methods and nursing bras for determining which breast was used in the previous breast feeding session, further improvements in the safety and effectiveness are desirable, and the present invention addresses the existing problems and provides related benefits.

### SUMMARY OF THE INVENTION

The present invention relates generally to the field of breast feeding, and particularly to a device for tracking breast feeding sessions and methods of use thereof by a nursing mother. The present invention is particularly adaptable as a reminder to a nursing mother of which breast was used during the previous breast feeding session, and thereby facilitating alternating breast feeding sessions. The present invention can be combined as an addition to any garment or article of clothing worn by a nursing mother for tracking alternating breast feeding sessions.

The present invention recognizes that tracking alternating breast feeding sessions can be made safer and more efficient by using a safe and simple device, which can be attached to a nursing mother's article of clothing indicating which breast was used during the previous breast feeding session, preferably the device is a self adhesive sticker that can be removable attached to a nursing mother's bra or nightgown.

A first aspect of the present invention is a device for tracking breast feeding sessions by a nursing mother including a sticker, which is preferably self adhesive and preferably removably attachable. The sticker may be attached on the right side or the left side of a nursing mother's article of clothing such as a bra or a nightgown. The sticker may optionally include a place, preferably a blank space, for recording the time and length of a breast feeding session so that the nursing mother can remember the time at which the last breast feeding took place and the length of time of the breast feeding session took, in addition to which breast was used during the last breast feeding session.

A second aspect of the present invention is a method of tracking breast feeding sessions by a nursing mother including the steps of providing a sticker, preferably a removable self adhesive sticker, and attaching the sticker on either the right side or the left side of a nursing mother's article of clothing, wherein the position of the attached sticker indicates which breast was used during the last breast feeding session.

A third aspect of the present invention is a method of alternate breast feeding by a nursing mother including the steps of attaching the sticker, preferably a removable self adhesive sticker, on either the right side or the left side of a nursing mother's article of clothing, wherein the position of the attached sticker indicates which breast should be used in the next breast feeding session.

### BRIEF DESCRIPTION OF THE DRAWINGS

FIG. 1 shows a perspective view of the sticker of the present invention having a blank area for recording the time and duration of a breast feeding session.

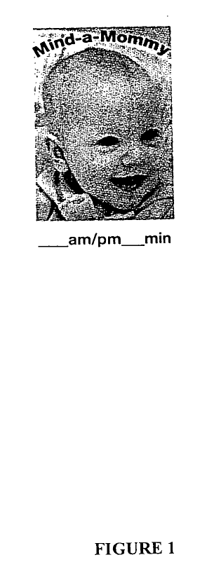

FIG. 2 show a perspective view of a conventional bra 20 worn by nursing mothers with attached sticker 21.

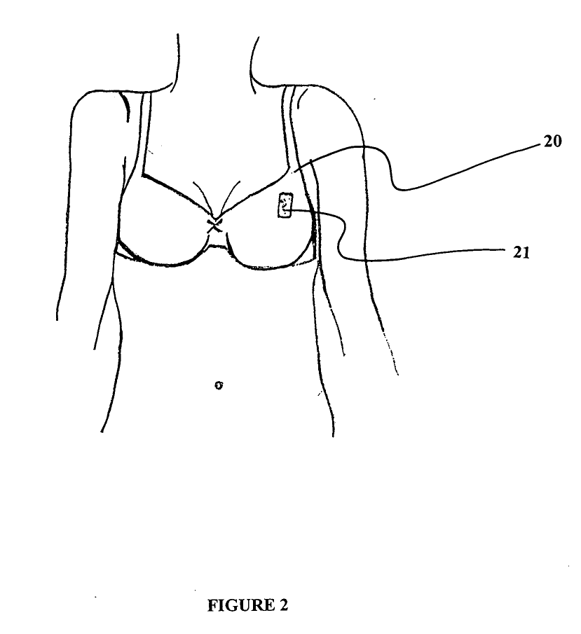

FIG. 3 show a perspective view of a conventional nightgown 30 worn by nursing mothers with attached sticker 31.

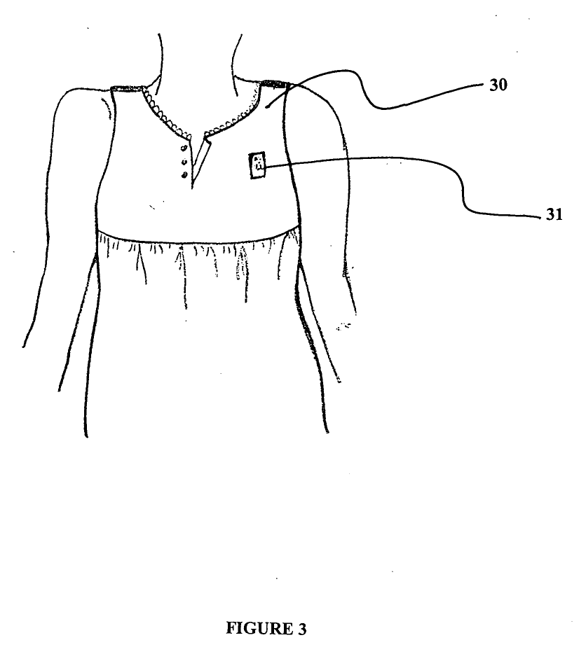

### DETAILED DESCRIPTION OF THE INVENTION

Introduction

The present invention recognizes that tracking alternating breast feeding sessions can be made safer and more efficient by using a safe and simple device, which can be attached to a nursing mother's article of clothing indicating which breast was used during the previous breast feeding session, preferably the device is a self adhesive sticker that can be removable attached to a nursing mother's bra or nightgown.

As a non-limiting introduction to the breadth of the present invention, the present invention includes several general and useful aspects, including:

1) a device for tracking breast feeding sessions by a nursing mother including a sticker, which is preferably self adhesive and preferably removably attachable. The sticker may be attached on the right side or the left side of a nursing mother's article of clothing such as a bra or a nightgown. The sticker may optionally include a place, preferably a blank space, for recording the time and length of a breast feeding session so that the nursing mother can remember the time at which the last breast feeding took place and the length of time of the breast feeding session took, in addition to which breast was used during the last breast feeding session.

2) a method of tracking breast feeding sessions by a nursing mother including the steps of providing a sticker, preferably a removable self adhesive sticker, and attaching the sticker on either the right side or the left side of a nursing mother's article of clothing, wherein the position of the attached sticker indicates which breast was used during the last breast feeding session.

3) method of alternate breast feeding by a nursing mother including the steps of attaching the sticker, preferably a removable self adhesive sticker, on either the right side or the left side of a nursing mother's article of clothing, wherein the position of the attached sticker indicates which breast should be used in the next breast feeding session.

The present invention relates a device for safely and efficiently tracking breast feeding sessions and methods of use thereof by a nursing mother. The present invention is particularly adaptable as a reminder to a nursing mother of which breast was used during the previous breast feeding session, and thereby facilitating alternating breast feeding sessions. The present invention can be combined as an addition to any garment, such as a bra or a nightgown worn by a nursing mother for tracking alternating breast feeding sessions.

Further objectives and advantages of the present invention will become apparent as the description proceeds and when taken in conjunction with the accompanying drawings. To gain a full appreciation of the scope of the present invention, it will be further recognized that various aspects of the present invention can be combined to make desirable embodiments of the invention.

Unless defined otherwise, all technical and scientific terms used herein have the same meaning as commonly understood by one of ordinary skill in the art to which this invention belongs. Where a term is provided in the singular, the inventor also contemplates the plural of that term. The nomenclature used herein and the procedures described below are those well known and commonly employed in the art.

I. Device for Tracking Breast Feeding Sessions by a Nursing Mother

The present invention includes device for tracking breast feeding sessions by a nursing mother including a sticker, which can be any type of sticker preferably having a self adhesive side for attachment to a nursing mother's garment. The sticker is preferably removably attachable with an adhesive that can be any type of removably attachable adhesive known in the art. Preferably the adhesive is non-toxic and reusable. The sticker may be of any size or shape that is able to indicate its location and presence to the nursing mother without interfering with the nursing mother's movements or the infant's movements during a breast feeding session. The sticker may be attached on the right side or the left side or of a nursing mother's article of clothing such as a bra or a nightgown at a secure location where it can be safely attached without interfering with the mother's arms or the infant's movements during a breast feeding session. The sticker may optionally include a place, preferably a blank space, for recording the time and length of a breast feeding session so that the nursing mother can record and remember the time at which the last breast feeding took place and the length of time of the breast feeding session took, in addition to which breast was used during the last breast feeding session.

II. A Method of Tracking Breast Feeding Sessions by a Nursing Mother

The present invention includes a method of tracking breast feeding sessions by a nursing mother including the steps of providing a sticker. The sticker is preferably removably attachable with an adhesive that can be any type of removably attachable adhesive known in the art. Preferably the adhesive is non-toxic and reusable. The sticker may be of any size or shape that is able to indicate its location and presence to the nursing mother without interfering with the nursing mother's movements or the infant's movements during a breast feeding session.

The present invention includes the step of attaching the sticker on the right side or the left side or of a nursing mother's article of clothing such as a bra or a nightgown, wherein the position of the attached sticker indicates which breast was used during the last breast feeding session. The sticker is preferably attached at a secure location where it can be safely attached without interfering with the mother's arms or the infant's movements during a breast feeding session. The sticker may optionally include a place, preferably a blank space, for recording the time and length of a breast feeding session so that the nursing mother can record and remember the time at which the last breast feeding took place and the length of time of the breast feeding session took, in addition to which breast was used during the last breast feeding session.

III. A Method of Alternate Breast Feeding by a Nursing Mother

The present invention includes a method of alternate breast feeding by a nursing mother including the steps of attaching a sticker on the right side or the left side or of a nursing mother's article of clothing such as a bra or a nightgown, wherein the position of the attached sticker indicates which breast was used during the last breast feeding session. The sticker is preferably attached at a secure location where it can be safely attached without interfering with the mother's arms or the infant's movements during a breast feeding session. The sticker may optionally include a place, preferably a blank space, for recording the time and length of a breast feeding session so that the nursing mother can record and remember the time at which the last breast feeding took place and the length of time of the breast feeding session took, in addition to which breast was used during the last breast feeding session.

Preferably the sticker is a removable self adhesive sticker, attached on either the right side or the left side of a nursing mother's article of clothing, wherein the position of the attached sticker indicates which breast should be used in the next breast feeding session. The sticker is preferably removably attachable with an adhesive that can be any type of removably attachable adhesive known in the art. Preferably the adhesive is non-toxic and reusable. The sticker may be of any size or shape that is able to indicate its location and presence to the nursing mother without interfering with the nursing mother's movements or the infant's movements during a breast feeding session.

All headings are for the convenience of the reader and should not be used to limit the meaning of the text that follows the heading, unless so specified. Various changes and departures may be made to the present invention without departing from the spirit and scope thereof. Accordingly, it is not intended that the invention be limited to that specifically described in the specification or as illustrated in the drawings, but only as set forth in the claims.

What is claimed is:

1. A device for tracking breast feeding sessions by a nursing mother comprising:
a sticker, optionally having a place for recording the time and length of said breast feeding session;
wherein, said sticker is placed on either the right side or the left side of an article of clothing worn by said nursing mother, indicating which breast was used during the last breast feeding session.

2. The method of claim 1, wherein said sticker is attached to either the right side or the left side of said nursing mother's bra.

3. The method of claim 1, wherein said sticker is attached to either the right side or the left side of said nursing mother's nightgown.

4. A method of tracking breast feeding sessions by a nursing mother comprising the steps of:
a) providing a sticker;
b) attaching said sticker on either the right side or the left of an article of clothing worn by said nursing mother;
wherein, the position of said attached sticker on said either right side or left side indicates which breast was used during the last breast feeding session.

5. The method of claim 4, further comprising the step of recording the time and length of said breast feeding session onto said sticker.

6. The method of claim 4, wherein said sticker is attached to either the right side or the left side of said nursing mother's bra.

7. The method of claim 6, further comprising the step of recording the time and length of said breast feeding session onto said sticker.

8. The method of claim 4, wherein said sticker is attached to either the right side or the left side of said nursing mother's nightgown.

9. The method of claim 8, further comprising the step of recording the time and length of said breast feeding session onto said sticker.

10. A method of alternate breast feeding by a nursing mother comprising the steps of:
a) attaching a sticker on either the right side or the left of an article of clothing worn by said nursing mother;
wherein, the position of said attached sticker on said either right side or left side indicates which alternate breast should be used in the next breast feeding session.

11. The method of claim 10, further comprising the step of recording the time and length of said breast feeding session onto said sticker.

12. The method of claim 10, wherein said sticker is attached to either the right side or the left side of said nursing mother's bra.

13. The method of claim 12, further comprising the step of recording the time and length of said breast feeding session onto said sticker.

14. The method of claim 10, wherein said sticker is attached to either the right side or the left side of said nursing mother's nightgown.

15. The method of claim 14, further comprising the step of recording the time and length of said breast feeding session onto said sticker.
